(19) United States
(12) Patent Application Publication
(10) Pub. No.: US 2007/0174449 A1
(43) Pub. Date: Jul. 26, 2007

(54) Method and system for identifying potential adverse network conditions

(76) Inventor: Ankur Gupta, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/487,248

(22) Filed: Jul. 14, 2006

(30) Foreign Application Priority Data
Jul. 22, 2005 (IN) IN987/CHE/2005

(51) Int. Cl. G06F 15/173

(52) U.S. Cl. 709/224

(57) ABSTRACT

A method and system for identifying potential adverse network conditions, the method including monitoring for events in the network, saving data indicative of the events, responding to an adverse network condition by electronically searching the events preceding the adverse network condition for patterns, and storing data indicative of the patterns associated with data indicative of the respective adverse network condition. The method may further include monitoring during run-time for matches or partial matches between the patterns and sequences of network events, and responding to a match or partial match by issuing a warning identifying the adverse network condition or conditions associated with a matched pattern or matched patterns.

### BACKGROUND OF THE INVENTION

Network management solutions focus principally on fault management and operate by reacting to reported network faults. The most common existing approach involves ascertaining a network's topology and then polling all objects or entities in that topology to determine whether those objects are operating normally. The polling is generally performed by means of the Internet Control Message Protocol (ICMP), an extension of the Internet Protocol, and the Simple Network Management Protocol (SNMP), an application layer protocol for facilitating the exchange of management information between network objects. Existing network management systems can determine network faults once the faulty network entity or entities have been polled.

For networks with larger topologies, however, it can take some time before the management station can complete the polling of all the entities in the network topology and hence, in may cases, until the faulty entity or entities have been polled. This constitutes a scalability problem: fault reporting becomes more difficult or is delayed as network size increases.

Another shortcoming of existing approaches is the lack of correlation between network faults, that is, an analysis of how one network fault is associated with other network faults.

One existing Root Cause Analysis (RCA) and event correlation software package is provided by EMC (a Massachusetts, U.S.A. corporation) under the trademark SMARTS. This package employs on a codebook approach in which a codebook that embodies vendor specific knowledge regarding events and their relationships is created. However, the codebook must be manually created so the correlation and RCA remain fundamentally reactive in nature, and only act after a fault has occurred.

### BRIEF DESCRIPTION OF THE DRAWING

Embodiments of the invention will now be described, by way of example only, with reference to the accompanying drawing, in which:

FIG. 1 is a schematic diagram of a network fault prediction system 102, together with a computer network 104.

FIG. 2 is a flow diagram of the steps performed by the system of FIG. 1 for preparing for predicting network fault detection.

FIG. 3 is a flow diagram of the steps performed by the system of FIG. 1 for monitoring for potential network faults.

FIG. 4 is a schematic diagram of a network management station and router for analysis potential network faults by means of the system of FIG. 1.

### DETAILED DESCRIPTION OF THE EMBODIMENTS

There will be described a method of identifying potential adverse conditions (such as alarms, faults or performance degradation) in a network. The method comprises monitoring for events in the network, saving data indicative of the events, responding to an adverse network condition by electronically searching the events preceding the adverse network condition for patterns, and storing data indicative of the patterns associated with data indicative of the respective adverse network condition.

In one embodiment, the method further includes monitoring during run-time for matches or partial matches between the patterns and sequences of network events, and responding to a match or partial match by issuing a warning identifying the adverse network condition or conditions associated with a matched pattern or matched patterns.

The events may comprise network alarms. In one embodiment, the method includes maintaining a database of network topology of the network and searching for patterns that comprise or consist of topological patterns.

Thus, according to the method, historical events are analysed to build associations between various network events; these associations may be based on the object (or entity) that generated those events, any temporal/spatial relationships between those events, and any relationship between the entities that generated those events. These associations are built as patterns of occurrences, which are constantly evaluated against incoming events. As incoming events start matching the patterns, early-warning events can be issued identifying potential network problems.

There is described in another broad aspect a system for identifying potential adverse conditions in a network. The system comprises an input for receiving data indicative of network events, a network event database for storing the data indicative of network events, a pattern database, and a processor for searching the data indicative of network events preceding an adverse network condition to identify patterns and for storing patterns so identified in the pattern database in association with data indicative of the respective adverse network condition.

The processor may be further operable to monitor during run-time for matches or partial matches between the patterns and sequences of network events, wherein the system is configured to respond to a match or partial match identified by the processor by issuing a warning identifying the adverse network condition or conditions associated with a matched pattern or matched patterns.

In one embodiment, the system includes a network topology database and is configured to maintain the network topology database, wherein the patterns can comprise topological patterns.

In another aspect there is described an apparatus for identifying potential adverse conditions in a network, comprising: a monitor for monitoring for events in the network; an electronic event database for storing data indicative of the events; a processor programmed to respond to an adverse network condition by electronically searching the electronic database for events preceding the adverse network condition exhibiting a pattern or patterns; and an electronic pattern database for storing data indicative any patterns identified by the processor and data indicative of respective adverse network conditions associated with the patterns. The processor is programmed to store the data indicative of the patterns in association with the data indicative of the respective associated adverse network conditions in the pattern database.

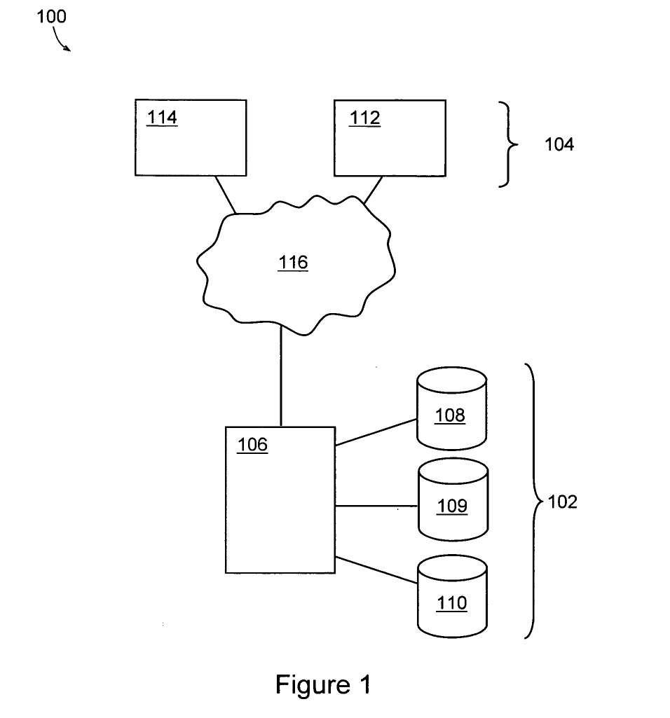

FIG. 1 illustrates schematically at 100 a network fault prediction system 102 according to an embodiment of the present invention, together with a computer network 104. The system 102 is arranged to predict faults (i.e. identify potential adverse events) in the computer network 104, and is provided with suitable program code and hardware to effect the various functions described below.

The principal hardware components of system 102 are a computer server 106, a network topology database 108, an event database 109 and pattern database or repository 110. The network topology database 108 contains data that specifies the relationship and hence topology of the network 104, and is updated as that topology is altered; the contents of the event database 109 and of the pattern repository 110 are discussed below. The network topology database 108, the event database 109 and the pattern repository 110 are in electronic communication with the server 106 by suitable means, or may be provided as components of the server 106.

The computer network 104 comprises various networked objects (including computers, printers, routers, switches, scanners and the like) shown collectively at 112, a network management station 114, and communications infrastructure 116. The networked objects 112 and the network management station 114 are in electronic communication via the communications infrastructure 116, which may be in the form of an intranet, the internet or like telecommunications mechanism. Individual networked objects 112 communicate, in some cases, via the communications infrastructure 116 but in other cases directly with each other. It will also be appreciated that in some arrangements, the communications infrastructure 116 will form—or at least be regarded as—a part of the computer network 104. This is typically the case when the computer network 104 comprises a local area network. However, when the communications infrastructure 116 comprises the internet for instance, it may be regarded as separate from the computer network 104.

The event database 109 is a continuously populated log of network events. These events are from a variety of sources, including SNMP traps from various networked objects, syslog and RMON messages from networked objects and internal events/traps/alarms generated by a management station.

The network fault prediction system 102 is in communication with the networked objects 112 and with the network management station 114 via the communications infrastructure 116. System 102 also includes, in addition to network topology database 108 and event database 109, software for performing various steps in order to predict network faults, as detailed below.

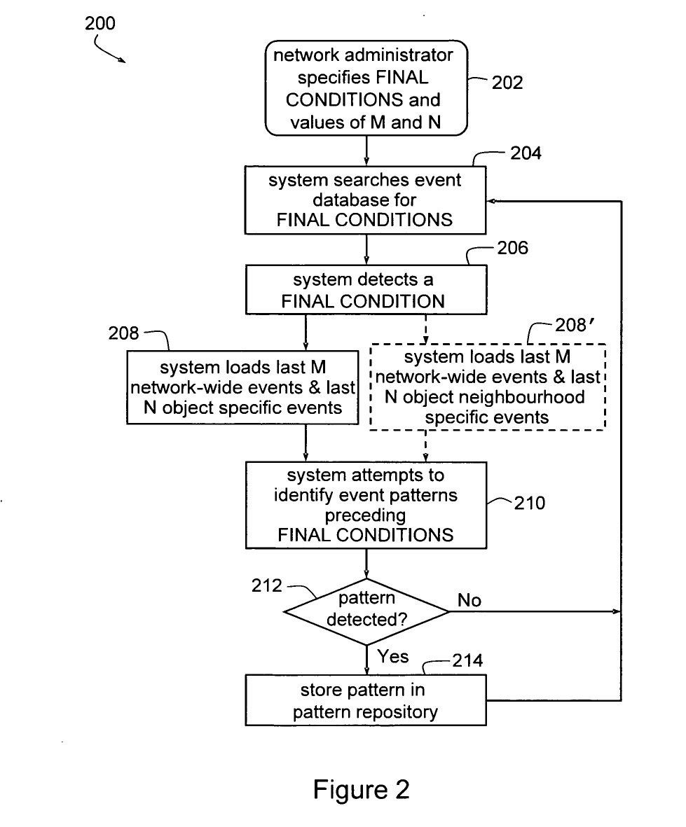

FIG. 2 is a flow diagram 200 of the steps performed by the system 102 for preparing for predicting network fault detection. At step 202, a network administrator of the computer network 104 specifies a list of network faults (such as “Router Down”, “High CPU usage” for a Router, “link down” and the like)—termed FINAL CONDITIONS in this embodiment—in which he or she is interested and values of M and N. M is the number of most recent network-wide events (that is, events relating to the entire network 104) preceding a FINAL CONDITION to be used in the analysis and N is the number of most recent object specific events preceding a FINAL CONDITION to be used in the analysis. For example, the network administrator might input a value of M of 50,000 and of N of 200. The exact values of these parameters do not have any particular significance, but are provided as a tool to limit the scope of the subsequent analysis. In general, it would be undesirable to have the system devote an excessive amount of time in analyzing past events (such as months of such events), and—in any case—old event data may in some cases relate to an old and superseded network topology.

At step 204, the system 102 searches the event database 109 for FINAL CONDITIONS. At step 206, the system 102 detects a FINAL CONDITION, that is, detects that an event describing that FINAL CONDITION exists in the event database and has been received from one of the networked objects 112 or from the network management station 114.

At step 208, the system 102 loads from the event database 109 the last M network-wide events and the last N object specific events preceding the detected FINAL CONDITION. In an alternative embodiment, at step 208′ the system 102 uploads from the event database N object neighbourhood specific events rather than N object specific events (that is, N events from the neighbourhood of an object, rather than from strictly objects themselves).

At step 210, the system 102 attempts to detect patterns within the last M network-wide events and the last N object (or object neighbourhood) specific events before the FINAL CONDITION event was reported. For example, these patterns may comprise repeated sequences of events, repeated or systematically varying time intervals between the occurrence of specific events, or relationships between the entities that generated events (such as that one is connected to the other, one is upstream of the other, or both are in a single standby routing protocol group or in the same VLAN). In searching for such patterns, the system 102 draws on the network topology information stored in the network topology database 108. Thus, the system 102 attempts to evaluate the temporal and spatial relationships between events in the event database 109 and the objects that generate those events to determine if any earlier events had a bearing on the FINAL CONDITION event. The detection of such event patterns is discussed in greater detail below.

At step 212 the system 102 checks whether a pattern has been detected. If so, the system 102 stores that pattern—at step 214—in pattern repository 110; the pattern repository 110 associates with each stored pattern a record of the FINAL CONDITION event before which the pattern occurred. The data in this repository, which collectively resembles a grammar with a set of rules, is thus built over time.

As discussed above, M is the number of events to be considered that do not relate to any particular object, so M is generally the sum of all the object specific local events that could be considered. However, it is possible in some circumstances that, for a particular FINAL CONDITION associated with a particular object, there are no local events (N) amongst the M system-wide events. In such cases, it may not be possible in the embodiment to identify any event patterns. This can be reported to the network administrator, so that he or she can increase the value of M.

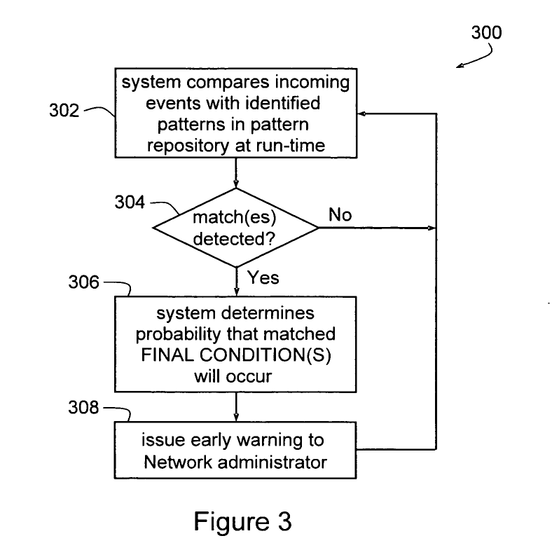

By this sequence of steps, the system 102 populates the pattern repository 110, for use in then monitoring for potential network faults. This monitoring phase is illustrated by means of flow diagram 300 of FIG. 3.

As indicated at step 302, at run-time system 102 continually compares the patterns in the pattern repository 110 with the incoming events in the event database. The system 102 then checks, at step 304, whether one or more matches or partial matches has been found.

The system 102 is programmed to determine a probability that each matched or partially matched (and hence predicted) FINAL CONDITION will occur. This is determined from the number of possible FINAL CONDITION events matched by a detected pattern of current events, preferably weighted by the percentage agreement in the match observed at step 304.

If a match or partial match has been found, at step 306 the system 102 issues an early-warning message to the network administrator, identifying the FINAL CONDITION or CONDITIONS associated with the matched pattern or patterns (which include partially matched patterns) and warning that this FINAL CONDITION or these FINAL CONDITIONS may soon occur. The warning message may thus indicate multiple FINAL CONDITIONS, each with a percentage indicative of its likelihood of occurrence relative to the others.

The system 102 then monitors for the predicted event or events to actually occur. If one or more do not occur, the system can add to the pattern repository 110, for those events that did not occur, a weighting can be calculated indicating that those events have a lesser probability of occurring. A table of patterns, events and likelihoods that the former will lead to the latter is built in the pattern repository 110. Subsequent warning issued at step 306 can therefore include further adjustment to the probabilities assigned to each predicted event on this basis.

As a result, the message sent to the network administrator at step 306 will not necessarily predict with absolute certainty what faults will occur, but they will provide useful predictions of likely faults that can be regarded as troubleshooting hints.

As an example of the use of the system 102, if—in a particular network 104—an upstream router's going down would cause all downstream devices to become unreachable and hence to be deemed to have failed, the impending network faults (i.e. the downstream failures) would be predicted by the system 102 in response to the going down of the upstream router. This prediction would be based on the system's ‘awareness’ of the network connectivity (derived from the network topology database 108) and on past downstream failure events that occurred after previous failures of the upstream router.

The system 102 thus provides an active approach to network fault management rather than, as in the background art, a reactive approach, by analysing past patterns or trends in network faults. It can take into account events generated by other network entities in the vicinity of a network entity being analysed for better impact analysis, automatically determine spatial and temporal relations between events, dynamically update correlation rules for better correlation of events, and hence provide early-warning information on impending network faults.

The patterns identified by the system 102 to be associated with a FINAL CONDITION event can also be used to provide information about the causes of faults, since the events forming the pattern will—in many cases—indicate the underlying problem or problems that cause the fault and not merely circumstances coincident with the fault. Analysis of the pattern of events found to coincide with the FINAL CONDITION can thereby be used to correct a fault's root cause rather than merely anticipate that fault.

As mentioned above, the network topology database 108 is updated as the topology of the network 104 is altered. Consequently, the system 102 will respond to changing network topology and events dynamically; patterns in topology can then be detected based on the current topology.

Pattern Detection

As discussed above, at step 210 the system 102 of this embodiment attempts to identify event patterns within the last M network-wide events and the last N object (or object neighbourhood) specific events before a FINAL CONDITION event was reported. To do so, the system 102 of this embodiment searches the event database and looks for the following five broad types of patterns.

1. Earlier Events from the Same Networked Device or Object

The system 102 attempts to identify error conditions that might have existed within a particular networked device or object and could have led to the FINAL CONDITION event.

For example, the network administrator may designate, as a FINAL CONDITION event, NODE_DOWN. A NODE_DOWN event is typically generated by the management station 114 whenever an individual node fails to respond to SNMP/ICMP. In this example the networked object is a specific Cisco brand switch that has gone down, prompting the management station 114 to emit a NODE_DOWN event for the switch. The system 102 searches the event database 109 for all events identified as having the switch as the source of the event. In this example, the system 102 locates two occurrences of the Cisco chassisAlarmOn trap: a chassisMajor alarm and a ChassisMinor alarm. If the chassisMajor alarm is recorded as having occurred later than the chassisMinor alarm, there is a high probability that the malfunction condition indicated by the chassisMajor alarm could be responsible for the failure of the node (which could be due, for example, to the failure of a power supply or to overheating following the failure of a cooling fan). The chassisMajor alarm followed by the NODE_DOWN is thus identified as a pattern. In general, alarms with the status “major” indicate serious malfunction conditions and, in this embodiment, are accorded a relatively high weight during analysis.

Alternatively, if the chassisMinor alarm is recorded as having occurred after the chassisMajor alarm, the normalization of the operational state of the switch chassis is indicated, which would be less likely to cause the entire switch to be unresponsive. In this case, the system 102 accordingly attempts to identify other potential causes of node failure. However, if none is found, the system 102 assigns a low probability to the occurrence of a NODE_DOWN event after the occurrence of a chassisMinor alarm.

Probabilities are computed by the system 102 according to the event patterns identified at step 210. These event patterns constitute a set of expected outcomes. For example, if an incoming event (that matches the first event in an identified pattern) has four different possible outcomes, the probability of occurrence of each outcome is set initially to 0.25 (in this simple example). If all four possible outcomes fails to occur, the system 102 concludes that a fifth possible outcome is possible and adjusts the probabilities to 0.2 for each. Thus, these probabilities are recomputed every time a new possible outcome (comprising a new pattern of event occurrence) is identified.

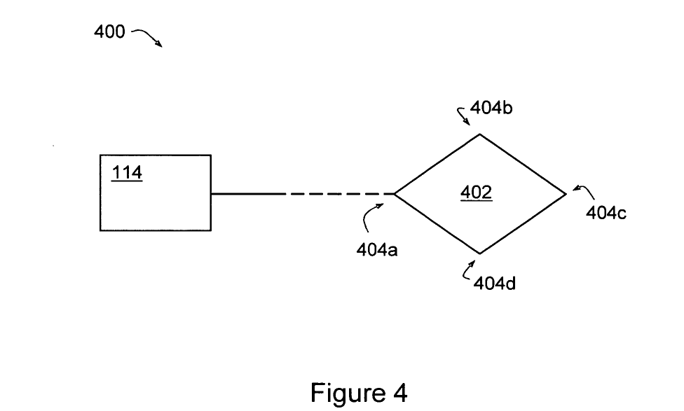

In another example of this first type of pattern, the networked object is in the form of a router, as shown schematically together with management station 114 at 402 in configuration 400 of FIG. 4. The router 402 has multiple interfaces 404a, 404b, 404c and 404d and the network topology shown in the figure; interface 404a has the SNMP management address. In this example, router 402 communicates with the management station 114 via interface 404a, and there exists no other network path between the management station 114 and the router 402. The other interfaces (404b, 404c and 404c) are connected to different networks (not shown). The network administrator again configures system 102 such that NODE_DOWN events are a FINAL CONDITION.

Suppose that a NODE_DOWN event occurs for router 402. The network fault prediction system 102 searches the event database 109 for events with the source as router 402. Suppose it finds the following sequence of five notional events (shown in increasing time order):

1. Interface 404b Down, Router 402

2. Interface 404c Down, Router 402

3. Router 402, status Minor

4. Interface 404a not responding, Router 402

5. Node Down, Router 402

An INTERFACE DOWN event is normally generated when the SNMP request for the ifOperStatus MIB variable returns the status value “DOWN”, given that the ifAdminStatus MIB variable has the value “UP”. An INTERFACE DOWN event typically signifies that the relevant device is still up, since the device is after all responding to SNMP. However, in this example, interface 404a is not responding to SNMP because, when interface 404a becomes non-operational, it takes down the SNMP management address with it. With this network topology, the device will always be marked as Down, since it cannot be reached through any other network path. The system 102 remembers not only the event but the particular interface that—through “not responding”—caused the device to be marked “Down”. Typically, when interface 404a does not respond to SNMP, the management station 114 tries to ping—and send SNMP requests—to all the other interfaces to determine whether the device is down or not. Depending on the number of interfaces on a device, this analysis can be expensive in terms of CPU consumption and time taken. The system 102 can send out an early warning NODE_DOWN event for router 402 after it encounters an unreachable event for interface 402, which can save computational overhead for the management station 114. This analysis remains accurate unless there is a topology change or the management address is assigned to a different interface, in which case the pattern identified by the system 102 is deleted and recomputed for the FINAL CONDITION event.

In a variation of this example, the management station 114 may compute the status of a device (such as router 402) on the basis of the status of its contained entities. For instance, the management station 114 could enforce a policy by which a device is marked as DOWN if 75% of its interfaces are DOWN. In such a case, the node/device in question may respond to SNMP, but is still marked as DOWN. The sequence of events might be as follows:

1. Interface 404b Down, Router 402

2. Interface 404c Down, Router 402

3. Node Minor, Router 402

4. Interface 404d Down, Router 402

5. Node Down, Router 402

In this case, there are only INTERFACE DOWN events, indicating that the device is still responding to SNMP. The interface list for a particular device is available from the topology database 108 through a well-defined interface (viz. topology APIs), so the system 102 responds by looking up the interface list for the device in question and computes the number of INTERFACE DOWN events as a percentage of the number interfaces for that device in the topology. This provides an indication of the effect of the having the management station 114 mark devices as “DOWN” based on the number of interfaces on that device that are “DOWN”.

2. Event(s) within a specific time of occurrence of a specified event from a networked device or object of interest

The system 102 attempts to identify patterns in the form of temporal relationships between events.

In a first example of such a pattern, the system 102 searches for occurrences of NODE_DOWN and NODE_UP events (the former being a critical event, the latter a normal event) within a time window of about 5 minutes. The window size of 5 minutes is a typical value provided as a guideline by many device vendors for performing event correlation based on temporal relationship between various events, but this window size can vary for different network management installations, depending on the configured frequency of polling for various network entities. However, the time window can be configured by the network administrator; a good value is generally a little greater than the configured frequency for polling of devices. For instance, if each router or switch in the network is to be polled at an interval of 5 minutes, then the corresponding NODE_UP event can only be generated when the device is next polled (after 5 minutes). In such circumstances a time window of say, 5 minutes and 20 seconds, might be preferred to cover for management station processing overheads and network latency, if any.

Typically the network administrator wants to focus on events that represent a malfunction or an error condition in the network. Event patterns such as a NODE_UP event following a NODE_DOWN event within a small time window should typically be suppressed, as the error condition (NODE_DOWN) stands corrected (NODE_UP) on its own.

Thus, the system 102 searches the event database 109 for event patterns based on temporal relationships, by searching for occurrences of complementary events from the same device or network entity within the configured time window. Hence, the NODE_DOWN—NODE_UP event pair would be identified as such an event pattern and placed in the event database 109. Another example of such an event pair is the INTERFACE_DOWN—INTERFACE_UP event pair. This is especially useful in identifying flapping interfaces, which are a nuisance for network administrators and generally due to the repeated creation and bringing down of dial-up connections. System 102 can identify such occurrences as they occur and alert the network administrator via an early warning alarm to take the necessary action (such as to disregard the event barrage). In these cases, system 102 attaches a probability of 0.5 that a DOWN event would be followed by a corresponding UP event for a particular network entity, given that such patterns have occurred in the past for that network entity. There is of course a 50% chance that the network entity continues to be DOWN, without the reception of the corresponding UP event.

System 102 can also adapted to detect repeated occurrences of such events (especially the NODE_DOWN—NODE_UP pair), as such events can indicate a security risk. For example, the device could be rebooted repeatedly due to a virus or denial of service attack. After a specified number of occurrences (configured by the network administrator, possibly three) of the event pair, the system 102 sends out an early warning alert to the network administrator indicating the possibility of a security risk.

System 102 can identify temporal relationships between the specified FINAL CONDITION event and any other event which occurs before or after the FINAL CONDITION event within the configured time window. Its scope is not limited to the notional example discussed above. Repeated occurrences of the same event within a specified time period can be identified and suppressed, if required. For instance, the Cisco Router syslog messages for CPU hogging (SYS-3-CPUHOG) and Configuration changes (SYS-5-CONFIG) are two such candidate events which can potentially have repeated occurrences for a router device within a short time period.

In a second example of this second type of pattern, the networked device is a Cisco 5000 Catalyst brand switch, and the system 102 attempts to detect whether the device was reset from the console as opposed to it being unreachable. With this Cisco brand switch, the “SYS-5:System reset” syslog message is received when the device is reset. The “SNMP-5:Cold Start” trap should be received in n minutes (n=switch reboot/reload time +1) after the occurrence of the “SYS-5:System reset” syslog event. If not this signifies a critical switch software error or operator intervention.

The system 102, after analysing these events, will have two possible event patterns in the event database 109: a “SYS-5:System reset” followed by a “SNMP-5:Cold Start” within n minutes, or a “SYS-5:System reset” followed by a NODE_DOWN event.

3. Events from the Neighbourhood of the Networked Device or Object

One of the challenges faced by network management solutions is to determine the root cause of a particular network fault. If a particular device is unreachable, it may be because a device that is upstream from the perspective of the location of the management station 114 is down, or because the device itself is down. If a router goes down the devices which are downstream from that router would not be reachable, assuming that there was no other network path to those devices.

In an example of this third type of event pattern, network administrator has configured the NODE_UNREACHABLE event for an important server, X, in a network as the FINAL CONDITION event for the system 102. System 102 uses the topology API to compute the set of devices that are in the neighbourhood of server X; the network administrator configures the number of hops from the node that the system 102 should treat as within the neighbourhood of server X. For instance, a hop count of 1 would result in the computation of the set of network entities directly connected to the server X (such as a switch) and a hop count of 2 would result in the computation of the set of devices connected to the devices that are directly connected to server X.

When the system 102 begins to analyse the event database 109 and encounters the NODE_UNREACHABLE event for server X, it searches for all events pertaining to devices in the computed neighbourhood of server X. Depending on the order in which the devices are polled, the events from the neighbourhood of server X could occur before the NODE_UNREACHABLE for server X or after its occurrence. The system 102 therefore scans for related events before and after the occurrence of the NODE_UNREACHABLE event for server X.

If server X is directly connected to a switch, Y, and the system 102 encounters the NODE_DOWN event for switch Y while analysing the FINAL CONDITION event for server X. Switch Y is in the immediate neighbourhood of server X, so switch Y's failure could be related to the unreachability of server X. This is identified as a pattern by the system 102. On the next occasion that the NODE_DOWN event for switch Y is received, the system 102 issues an early warning alarm to indicate that the server X is unreachable.

A prior art network management station would be unable to compute these scenarios without polling all the devices in the neighbourhood, which could potentially take a longer time depending on the polling frequency and how the internal polled object lists are maintained by the network management station. In addition, neighbourhood analysis at run-time is an overhead and would result in delayed reporting of root-cause failures, much after the actual failure occurred.

4. Events from Other Networked Devices/Objects that Participate in a Relationship with that Device/Object (such as HSRP Group, VLAN Member Switches, Multi-cast Group (Impact Analysis))

In an example of this fourth type of event pattern, a switched network has various VLANs and an active Spanning Tree Protocol (STP) for ensuring a loop-free switched topology. The FINAL CONDITION event is set to be a STP reconfiguration event indicated by the “SPANTREE-6” series of syslog messages. The STP reconfiguration could be due to the failure of a device in the spanning tree, the device's removal from service, the addition of the device to the network or the failure of a link between two switches participating in the spanning tree.

The system 102 computes the set of all devices participating in the VLAN and the spanning tree, by using the interface to the topology database, and then searches for any prior events from those devices. For instance, if two switches are connected to each other, an INTERFACE_DOWN event on the first switch will take the corresponding connecting interface on the second switch down with it (i.e. the connecting link will go down). If both of these switches were participating in the spanning tree, a spanning tree reconfiguration may result. In this case the following event pattern is identified by the system 102:
1. INTERFACE_DOWN on switch 1
2. LINK_DOWN switch 1 and switch 2
3. STP_RECONFIGURATION event

Another possible event pattern for a switch X participating in VLAN Y and the corresponding spanning tree could be:
1. INTERFACE_DOWN on switch X
2. NODE_DOWN switch X
3. VLAN_TOPOLOGY_CHANGE event VLAN Y
4. STP_RECONFIGURATION event VLAN Y

Thus, system 102 takes into account the participative relationships within a network, enabling it to perform an effective impact analysis. A switch may participate in a VLAN and a spanning tree. Similarly, a router may participate in a HSRP or multicast group. The system 102 is configured to detect these kinds of relationships.

5. General Relationships

The system 102 is also configured to attempt to determine the following: How does the occurrence of a specified event affect the network in general? Does the event cause congestion? Does it cause performance degradation? How does it affect the higher order services, built on top of various network elements?

System 102 does not work exclusively on hard-coded correlation rules, it is sufficiently flexible to recognize events and to deduce conditions in the network that occurred or existed prior to certain events all based on past network behaviour. For example, a service impact event for the Microsoft brand Exchange Server could be generated by any service management solution. This being so, the system 102 is configured to respond by looking up all occurrences of this event in the event database 109 and—for each occurrence—attempt to determine if there existed a network event that could be correlated to the service impact event. This could be due to an interface on the server running the Microsoft exchange service being down or the server itself being down.

### CONCLUSION

Each pattern stored in the repository represents a likely sequence of events, which could occur before the occurrence of the FINAL CONDITION event. This has the advantage that the event correlation rules need not be specified. Each vendor provides proprietary events and event correlation scenario, so a comprehensive event correlation solution that is vendor agnostic is likely either to be impossible or impractical; system 102 of this embodiment identifies correlations between events automatically and thus avoid this difficulty.

The foregoing description of the exemplary embodiments is provided to enable any person skilled in the art to make or use the present invention. While the invention has been described with respect to particular illustrated embodiments, various modifications to these embodiments will readily be apparent to those skilled in the art, and the generic principles defined herein may be applied to other embodiments without departing from the spirit or scope of the invention. It is therefore desired that the present embodiments be considered in all respects as illustrative and not restrictive. Accordingly, the present invention is not intended to be limited to the embodiments described above but is to be accorded the widest scope consistent with the principles and novel features disclosed herein.

1. A method of identifying potential adverse conditions in a network, comprising:
monitoring for events in said network;
saving data indicative of said events;
responding to an adverse network condition by electronically searching said events preceding said adverse network condition for patterns; and
storing data indicative of said patterns associated with data indicative of the respective adverse network condition.

2. A method as claimed in claim 1, further including:
monitoring during run-time for matches or partial matches between said patterns and sequences of network events; and
responding to a match or partial match by issuing a warning identifying the adverse network condition or conditions associated with a matched pattern or matched patterns.

3. A method as claimed in claim 2, further including determining for each of said adverse network conditions associated with said matched patterns a probability of occurrence, and outputting said probability or probabilities.

4. A method as claimed in claim 1, including maintaining a database of network topology of the network and searching for patterns that comprise or consist of topological patterns.

5. A method as claimed in claim 1, wherein said patterns are selected from the group comprising: a plurality of distinct events from a networked object, an event or events occurring within a specified time of occurrence of a specified event from a networked object, an event or events from a neighbourhood of a networked device, an event or events from networked objects that participate in a relationship with a specific networked object, and events with an identifiable relationship.

6. A system for identifying potential adverse conditions in a network, comprising:
an input for receiving data indicative of network events;
a network event database for storing said data indicative of network events;
a pattern database; and
a processor for searching said data indicative of network events preceding an adverse network condition to identify patterns and for storing patterns so identified in said pattern database in association with data indicative of the respective adverse network condition.

7. A system as claimed in claim 6, wherein said processor is further operable to monitor during run-time for matches or partial matches between said patterns and sequences of network events, wherein said system is configured to respond to a match or partial match identified by said processor by issuing a warning identifying the adverse network condition or conditions associated with a matched pattern or matched patterns.

8. A system as claimed in claim 7, wherein said processor is operable to determine for each of said adverse network conditions associated with said matched patterns a probability of occurrence, and said system is operable to output said probability or probabilities.

9. A system as claimed in claim 6, further including a network topology database, wherein the system is configured to maintain the network topology database so that patterns can comprise topological patterns.

10. An apparatus for identifying potential adverse conditions in a network, comprising:
a monitor for monitoring for events in said network;
an electronic event database for storing data indicative of said events;
a processor programmed to respond to an adverse network condition by electronically searching said electronic database for events preceding said adverse network condition exhibiting a pattern or patterns; and
an electronic pattern database for storing data indicative any patterns identified by said processor and data indicative of respective adverse network conditions associated with said patterns;
wherein said processor is programmed to store said data indicative of said patterns in association with said data indicative of said respective associated adverse network conditions in said pattern database.

11. An apparatus as claimed in claim 10, wherein said processor is further programmed to compare said patterns stored in said pattern database with events in said network during run-time and to identify matches or partial matches between therebetween, and to respond to a match or partial match by issuing a warning identifying the adverse network condition or conditions associated with a matched pattern or matched patterns, and said apparatus includes an output for outputting said alert.

12. A computing device provided with program data that, when executed on the device, implements the method of claim 1.

13. A computer readable medium provided with program data that, when executed on a computing device, implements the method of claim 1.
